(19) United States
(12) Patent Application Publication
(10) Pub. No.: US 2007/0297871 A1
(43) Pub. Date: Dec. 27, 2007

(54) Power tap structure

(76) Inventors: Ying-Kung Lu, Taipei Hsien (TW); Feng-Song Tsai, Taipei Hsien (TW)

Correspondence Address: Ying-Kung Lu, 235 Chung - Ho, Box 8-24, Taipei, omitted

(21) Appl. No.: 11/474,226

(22) Filed: Jun. 26, 2006

(51) Int. Cl. F16B 25/10

(52) U.S. Cl. 411/387.1; 411/413

(57) ABSTRACT

A power tap structure comprises a screw head, a bolt being a rod body extended underneath the screw head, and at least two screw thread units having different cutting surfaces respectively called a cutting thread and a retaining thread. Each of the crew thread units further includes a plurality of thread sections connected by a transition screw thread. The cutting thread has a plurality of indentations distributed along a cutting thread surface thereon, whereby the indentations on the cutting thread will effectively cut fibers of a material the bolt is being inserted. Therefore, the screw will penetrate the material quickly and easily. Further, an additional thread unit with narrower pitch can be formed right below the screw head for enhancing the locking effect of the screw when it is embedded into the material.

### FIELD OF THE INVENTION

The present invention relates to improvements of power tap structure, more particularly to a power tap structure on a screw that can be embedded in a material quickly and stably, saving labor.

### BACKGROUND OF THE INVENTION

A screw 1 of the prior art comprises a screw head 11, a bolt 12 extended underneath the head 11 and a screw thread unit 13 formed on the bolt 12, whereby a user will apply a twist force on the screw head 11 to drive the screw thread unit 13 gradually cutting through a material for attachment 2, and whereby the screw 1 will be eventually retained within the a material for attachment 2.

1. Slow Screwing Speed:

The screw thread unit 13 is wound around the bolt 12 without interruption. Therefore, the effect of cutting as well as locking (within a material) is uniquely determined by the sharpness and pitch of the screw thread unit 13. If the screw thread unit 13 cannot cut the fibers of the material effectively, the screwing speed will become slow and the screwing operation is laborious.

2. Loose Locking Condition:

The embedment of the screw thread unit 13 within a material (such as a wooden material) is further stabilized by fibers of the material engaged with the thread groove formed in the screwing. However, since the thread groove of the screw thread unit 13 is continuous, the fibers formed has a elongated shape and sometimes cannot be guided along the groove, increasing the resistance on the screw 1 when derived into the material. Therefore, a worker needs to apply larger force. Consequently, the screw thread is easier to wear out or get deformed, losing its locking effect. The selection of pitch of the screw thread is a compromise between cutting and locking; the wider the pitch, the better the penetrating effect is and the less effective the locking is. Therefore, there exists room for improvement regarding the screw thread on a screw.

### SUMMARY OF THE INVENTION

The primary objective of the present invention is to provide an improved power tap structure wherein one thread unit with a large pitch angle will facilitate cutting and the indentations thereon will cut off fibers and eject the fibers out of the thread groove. Therefore, a screw of the present invention will penetrate a wooden material quickly and easily.

Accordingly, a power tap structure comprises a screw head, a bolt being a rod body extended underneath the screw head, and at least two screw thread units having different cutting surfaces respectively called a cutting thread and a retaining thread. Each of the crew thread units further includes a plurality of thread sections connected by a transition screw thread. The cutting thread has a plurality of indentations distributed along a cutting thread surface thereon, whereby the indentations on the cutting thread will effectively cut fibers of a material the bolt is being inserted. Therefore, the screw will penetrate the material quickly and easily. The depth of the indentations is shorter than the thickness of the cutting thread surface, and therefore the cutting effect of the cutting thread is unaffected. There exists another screw thread adjacent to the main cutting thread, which has a larger pitch angle and a lower thread surface height. The additional thread is for enhancing penetrating power of the cutting, therefore being laborsaving. Therefore, as the screw is penetrating a material, the cutting thread will penetrate the material, while the indentations will cut off the fibers accumulated in the cutting thread groove, facilitating a fast and laborsaving operation.

Further, an additional thread unit with narrower pitch can be formed right below the screw head for enhancing the locking effect of the screw when it is embedded into the material.

### BRIEF DESCRIPTION OF THE DRAWINGS

FIG. 1 is a perspective view of a screw of the prior art.

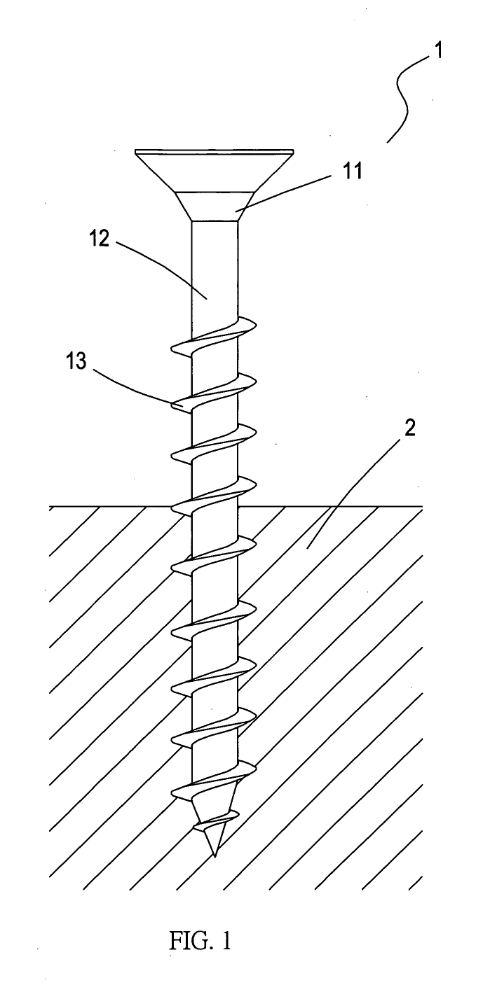

FIG. 2 is a front view of a power tap of the present invention.

FIG. 3 is a perspective view of the power tap structure in FIG. 2 before it is finally formed.

FIG. 4 illustrates the power tap structure in FIG. 2 cutting into a wooden material.

FIG. 5 is a perspective view of the power tap structure in FIG. 2.

### DETAILED DESCRIPTION OF THE PREFERRED EMBODIMENTS

The various objects and advantages of the present invention will be more readily understood from the following detailed description when read in conjunction with the appended drawings.

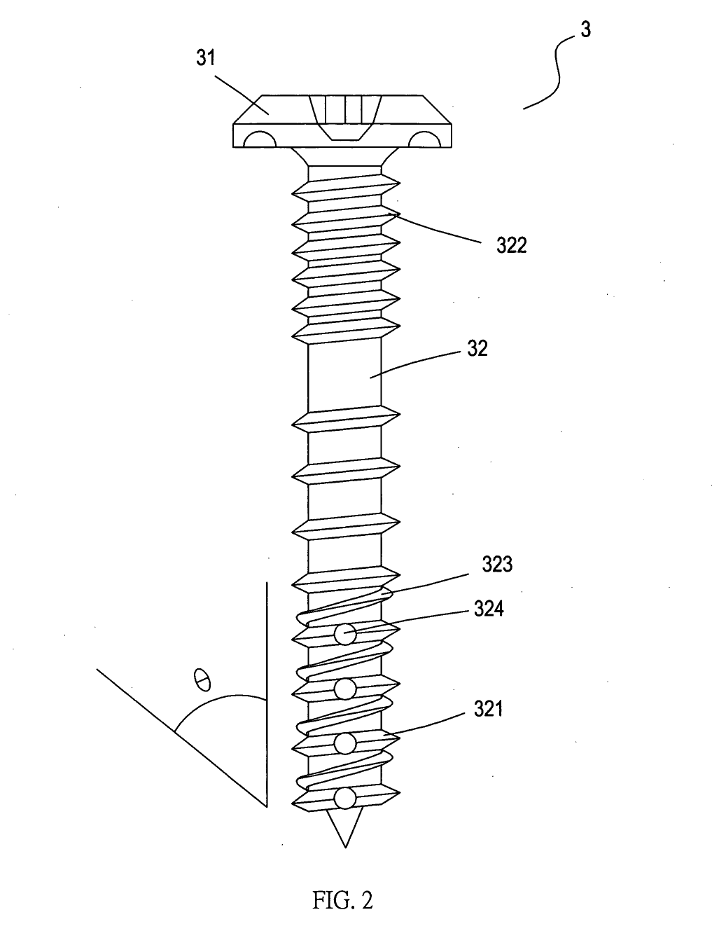

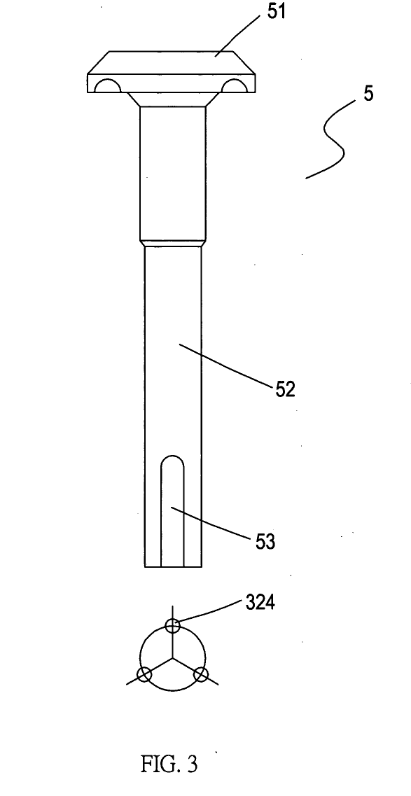

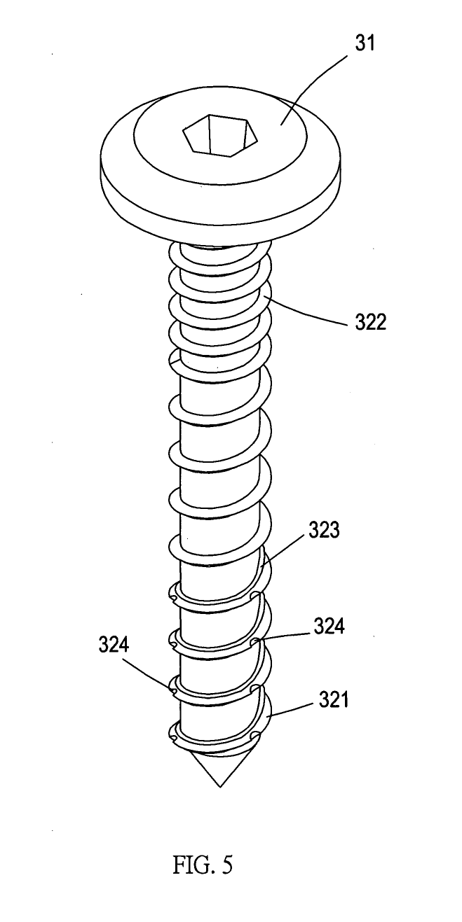

Referring to FIGS. 2 and 5, a power tap structure comprises a screw head 31, a bolt 32 being a rod body extended below the screw head 31 and at least two screw thread units of different cutting surfaces. Those two screw thread units are respectively a main thread section 321 having a more horizontal pitch angle for cutting through a wooden material and a rear thread section 322 for retaining the screw in the material. There is another assisting thread section 323 with a more vertical pitch angle for facilitating the main thread section 321 cutting into the material. At the same time, the assisting thread section 323 can eject the fibers formed in the cutting out of the hole of engagement. Therefore, the height of cutting surface of the assisting thread section 323 is lower than the height of the cutting surface of the main thread section 321. Each of the thread units further includes a plurality of thread sections. Some portion of the main thread section 321 is evenly distributed with a plurality of indentations, as shown in FIG. 3. In this preferred embodiment, the indentations are 3 holes 324 on the cutting surface in the groove 3, 120 degrees apart. The manufacturing process of the screw is listed below.

The assisting thread section associated with the two thread sections is for destructive penetration into the wooden material, which has multiple effects of penetration, grinding and debris ejection. Therefore, the pitch angle θ is more vertical for saving labor. Further, the hole formed by the assisting thread cannot be too large; otherwise the material will not retain the screw. Therefore, the height of the cutting surface of the assisting thread should be smaller then the height of the main thread.

The main thread section 321 (sw thread) has a predetermined pitch angle, whereby as the screw cutting into the embedding material 4 a wider helical groove will be formed in the material. The upper screw thread 322 that follows has a smaller pitch and will form tighter helical groove for better locking.

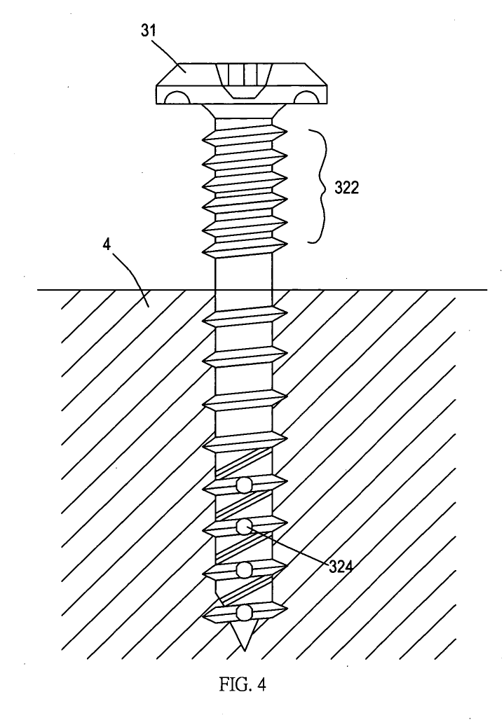

Referring to FIG. 4, a worker applies a torsion force on the screw head 31 to drive the thread units on the bolt to cut through the embedding material. The main cutting thread, equipped with a plurality of holes on the thread surface, will follow the assisting thread 323 with a more vertical pitch angle for facilitating the invasion into the material. Thereby, the screw can penetrate the material efficiently and at the same time lock with the material tightly.

Further, the method of making a screw of the present invention, as shown in FIG. 3, includes the steps of:

1. forming the bold, which is a rod body 52 below the screw head 51;

2. cutting a groove 53 with 120 inclination angle in the lower section of the rod body 52;

3. cutting around the rod body 52 to form a near horizontal main thread 321 and a more vertical assisting thread 323; and

4. forming a screw of the present invention.

The present invention has the following advantages:

1. Fast and labor-saving locking:

A transitional thread links the two thread units in the front section of the screw, whereby the wooden fibers formed in the process cutting can be effectively cut off. Further, the indentations evenly distributed on the cutting thread surface 120 degrees apart can store the wooden fibers formed in the process of locking, thereby avoiding the interference of the fibers with the screw being inserted.

2. Enhanced attachment:

The front thread unit has a wider pitch and therefore can cut into a wooden material easily. But the retaining effect of the thread unit is not good enough. On the other hand, the rear thread unit has a narrower pitch, and the engagement between the rear thread unit and the wooden material are tighter.

The present invention is thus described, and it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A power tap structure, comprising:
a screw head;
a bolt being a rod body extended underneath said screw head; and
at least two screw thread units having different cutting surfaces respectively called a cutting thread and a retaining thread, each of said crew thread units further including a plurality of thread sections connected by a transition screw thread, said cutting thread having a plurality of indentations distributed along a cutting thread surface thereon, whereby said indentations on said cutting thread will effectively cut fibers of a material said bolt is being inserted, and whereby said screw will penetrate said material quickly and easily.

2. The power tap structure of claim 1 wherein said indentations on said cutting thread surface are evenly distributed with an angular displacement 120 degrees apart.

3. The power tap structure of claim 1 wherein the inclination angle of said cutting thread is larger than that of said retaining thread.

4. The power tap structure of claim 1 wherein an additional thread unit with pitch equal to that of an adjacent one of said thread units can be formed right below said screw head for enhancing locking effect of said screw.

5. The power tap structure of claim 1 wherein an additional thread unit with pitch narrower than those of said thread units can be formed right below said screw head for enhancing locking effect of said screw.
